(19) United States
(12) Patent Application Publication
(10) Pub. No.: US 2014/0060519 A1
(43) Pub. Date: Mar. 6, 2014

(54) Generation Of Steam For Use In An Industrial Process

(71) Applicants: David Bent, Bridgend (GB); Keith Davies, Miskin (GB)

(72) Inventors: David Bent, Bridgend (GB); Keith Davies, Miskin (GB)

(21) Appl. No.: 14/007,032

(22) PCT Filed: Mar. 26, 2012
(86) PCT No.: PCT/GB12/50663

§ 371 Date: Nov. 18, 2013

(30) Foreign Application Priority Data
Mar. 24, 2011 (GB) 1104975.6
Oct. 26, 2011 (GB) 11181518.8

(51) Int. Cl. F03G 6/00; F24J 2/46

(52) U.S. Cl. CPC F03G 6/005; F24J 2/46
USPC 126/714; 60/641.8

(57) ABSTRACT

A method of generating steam for use in an industrial process is disclosed. The industrial process may for example be power generation or desalination. The method comprises: (a) pressurising a working fluid liquid comprising water to a first pressure; (b) heating the working fluid liquid to a temperature substantially equal to the saturation temperature of the working fluid liquid at the first pressure; and (c) flash evaporating the working fluid liquid to generate steam. The pressurised working fluid liquid is heated in step (b) by direct heating in a solar radiation absorption device. Also disclosed is an apparatus for generating steam for use in an industrial process. The apparatus comprises a pump (32) for pressurising a working fluid liquid comprising water to a first pressure; a heating unit (34) downstream of the pump (32) for heating the working fluid liquid to a temperature substantially equal to the saturation temperature of the working fluid liquid at the first pressure; and a cooperating throttle valve (36) and flash tank (38) downstream of the heating unit (34) for flash evaporating the working fluid liquid to generate steam. The heating unit (34l ) comprises a solar radiation absorption device for direct heating of the pressurised working fluid.

The present invention relates to a method and apparatus for the generation of steam for use in an industrial process, using solar energy. The invention relates particularly but not exclusively to the generation of steam for use in power generation and/or desalination applications.

### BACKGROUND

Power generation at a utility scale (>10 MW) conventionally requires large amounts of steam at controlled temperatures and pressures to drive turbines and generate electricity. This working fluid vapour is usually superheated steam. Heat input is required to raise the necessary steam and then superheat the steam to the required temperatures for turbine operation. The heat input may come from a variety of sources, but the present invention is concerned with applications using solar energy as the primary source of heat energy.

In a typical Concentrated Solar Power plant, a heat transfer fluid loop is used to collect energy from the sun and raise superheated steam which is then fed to a turbine for electricity generation. Examples of such known systems are disclosed in WO2009/034577 and WO2007/093474. The heat transfer fluid loop in such known systems represents a significant proportion of plant capital cost, and alternative configurations have therefore been explored in which superheated steam is raised directly in one or more solar absorption devices. EP1890035 discloses a solar power plant in which a parabolic trough collector is used for generating saturated or slightly superheated vapour, and a three dimensional solar collector is used to superheat the vapour generated in the parabolic trough collector. A plant of this type avoids the capital cost of the heat transfer fluid loop and the boiler of the more conventional configurations. However, the two phase flow regime in the parabolic trough collectors in which the water is boiled can lead to problems with collector tube buckling and system controllability.

Another industrial process which may require large amounts of working fluid vapour is desalination, in which fresh water that is suitable for human consumption or irrigation is raised from salt water. In a desalination process, fresh water is evaporated off feed salt water for subsequent condensation and use. A preferred method of evaporating the fresh water is vacuum distillation, owing to the reduced energy costs of low pressure evaporation. However, boiling by heat exchange with a heat transfer fluid, which may be liquid or vapour, is also known. These processes are very large energy consumers.

U.S. Pat. No. 4,670,705 discloses a Rankine cycle power plant which utilizes as a working fluid various hydrocarbon compounds, which are highly flammable.

### SUMMARY

The present invention represents an improvement over the known systems described above, and involves raising steam directly from a pressurised working fluid liquid comprising water by flash evaporation. The pressurised working fluid liquid is heated to a temperature close to its saturation temperature at the increased pressure using direct heating in a solar radiation absorption device. The pressurised and heated working fluid liquid is then flash evaporated to generate working fluid vapour. In this manner, the problem of two phase flow in collector tubes of solar absorption devices is avoided, without the need for recourse to a conventional heat transfer fluid loop and boiler. The generated working fluid vapour may then be superheated and fed to a turbine for power generation, or may be used as a heat transfer fluid for other applications, such as desalination. In one embodiment, the working fluid liquid may be preheated and the working fluid vapour may be superheated, one or both of which processes may be conducted using direct solar heating in a further solar radiation absorption device or devices.

Thus, according to a first aspect of the present invention, there is provided a method of generating steam for use in an industrial process, comprising:
(a) pressurising a working fluid liquid comprising water to a first pressure of at least 50 bar (abs);
(b) heating the working fluid liquid to a temperature substantially equal to the saturation temperature of the working fluid liquid at the first pressure; and
(c) flash evaporating the working fluid liquid to generate steam;
wherein the pressurised working fluid liquid is heated in step (b) by direct heating in a solar radiation absorption device.

For the purposes of the present specification, “substantially equal to” encompasses a functional margin of error including that range of temperatures up to and including the saturation temperature at which flash evaporation may occur. This functional margin of error also allows for unavoidable pressure losses during the heating stage which may be of the region of 1%. Thus, according to embodiments of the invention, “substantially equal to” encompasses temperatures up to 5° C. below the saturation temperature at the first pressure.

The working fluid liquid comprising water may be boiler feed water. “Boiler feed water” is water which is used to supply a boiler to generate steam, which has been treated to remove impurities which could lead to corrosion problems or deposits in the boiler, and may include additives, such as alkaline agents, to improve performance.

The working fluid may be supplied to step (a) at a base line pressure, the pressurising of step (a) increasing the pressure of the working fluid above the base line pressure to the first pressure.

The industrial process may be power generation, in which the steam may be employed to drive a turbine. In such applications, additional preheating of the working fluid liquid before the solar preheating stage may be conducted using auxiliary steam from turbines.

In power generation embodiments, the scale of the method may be at least 10 MW, or at least 50 MW, or at least 100 MW, or at least 150 MW.

The flash evaporation may be carried out in a flash tank which receives saturated, pressurised water from the solar radiation absorption device via a throttle valve.

The solar radiation absorption device may comprise a linear Fresnel absorption device or may comprise parabolic tough device. The parabolic trough device may have a stationary collector pipe and may for example comprise a parabolic trough device according to GB1008032.3

The method may further comprise preheating the working fluid liquid before pressurising at step (a).

Preheating may be carried out by direct heating in a solar radiation absorption device, which may comprise one or more linear Fresnel solar absorption devices.

The method may further comprise superheating the steam after step (c).

The steam may be superheated by a source of heat different from the heated working fluid. Superheating may be carried out by direct heating in a solar radiation absorption device which may comprise one or more tower solar absorption devices. Additionally, or in the alternative, the solar radiation absorption device may comprise one or more linear Fresnel solar radiation absorption devices.

Superheating may comprise first and second superheating stages, in which the first superheating stage may use direct solar heating and the second superheating stage may use a non renewable energy source. In an alternative embodiment, fossil fuel heating may be used for the first superheating stage or for both superheating stages.

The first superheating stage may use one or more tower solar absorption devices and/or one or more linear Fresnel solar absorption devices and the second superheating stage may use fossil fuels, a biofuel or a biomass material.

The working fluid liquid remaining after flash evaporation in step (c) may be recycled back to step (a). In one embodiment, between 5% and 15% of the working fluid liquid may be flash evaporated to vapour in step (c), the remaining liquid being recycled to step (a). In a particular embodiment, between 7% and 8% of the working fluid liquid may be flash evaporated to vapour in step (c).

The industrial process may be combined power generation and desalination.

According to a second aspect of the present invention, there is provided a method of power generation comprising:
generating steam by a method according to the first aspect of the present invention; and
supplying the steam to a turbine for power generation.

According to a third aspect of the preset invention, there is provided a method of generating steam for use in a desalination process, comprising:
(a) pressurising a working fluid liquid comprising water to a first pressure of 5-50 bar (abs);
(b) heating the working fluid liquid to a temperature substantially equal to the saturation temperature of the working fluid liquid at the first pressure; and
(c) flash evaporating the working fluid liquid to generate the steam; wherein the pressurised working fluid liquid is heated in step (b) by direct heating in a solar radiation absorption device.

According to the third aspect, the steam may be employed as a heat transfer fluid to boil feed water for desalination.

The flash evaporation may be carried out in a flash tank which receives saturated, pressurised water from the solar radiation absorption device via a throttle valve.

The working fluid liquid remaining after flash evaporation in step (c) may be recycled back to step (a). In one embodiment, between 5% and 15% of the working fluid liquid may be flash evaporated to vapour in step (c), the remaining liquid being recycled to step (a). In a particular embodiment, between 7% and 8% of the working fluid liquid may be flash evaporated to vapour in step (c).

According to a fourth aspect of the present invention, there is provided an apparatus for generating steam for use in an industrial process, the apparatus comprising:
a pump for pressurising a working fluid liquid comprising water to a first pressure of at least 50 bar (abs);
a heating unit downstream of the pump for heating the working fluid liquid to a temperature substantially equal to the saturation temperature of the working fluid liquid at the first pressure; and
a cooperating throttle valve and flash tank downstream of the heating unit for flash evaporating the working fluid liquid to steam,
wherein the heating unit comprises a solar radiation absorption device for direct heating of the pressurised working fluid.

The pump may comprise a high pressure pump. The pump may be operable to increase a pressure of the working fluid from a base line pressure to the first pressure P.

The industrial process may be power generation, in which the steam may be employed to drive a turbine. In such applications, additional preheating of the working fluid liquid before the solar preheating stage may be conducted using auxiliary steam from turbines.

The heating unit may be in fluid communication with the flash tank via the throttle valve.

The solar radiation absorption device may comprise one or more parabolic trough solar absorption devices. Alternatively, or in addition, the solar radiation absorption device may comprise one or more linear Fresnel solar radiation absorption devices.

The or each parabolic trough device may comprise a stationary collector pipe and may for example comprise a parabolic trough device according to GB1008032.3

The apparatus may further comprise a recycle loop which may be configured to feed working fluid liquid from the flash tank to the pump.

The pump, heating unit and cooperating throttle valve and flash tank may together comprise a steam generating zone, and the apparatus may further comprise a preheating zone upstream of the steam generating zone for preheating the working fluid liquid and a superheating zone downstream of the steam generating zone for superheating the steam.

The preheating zone may comprise a solar radiation absorption device for direct heating of the working fluid liquid. The solar radiation absorption device may comprise one or more linear Fresnel solar absorption devices.

The superheating zone may comprise a source of heat different from the heated working fluid. The superheating zone may comprise a solar radiation absorption device for direct heating of the steam. The solar radiation absorption device may comprise one or more tower solar radiation absorption devices. Alternatively, or in addition, the solar radiation absorption device may comprise one or more linear Fresnel solar radiation absorption devices.

The superheating zone may comprise first and second superheating stages, the first superheating stage comprising a tower solar radiation absorption device and/or one or more linear Fresnel solar absorption devices and the second superheating stage comprising a fossil fuel burner. Alternatively a fossil fuel burner could be used for one or both superheating stages.

The industrial process may comprise combined power generation and desalination, in which the steam may be employed both to drive a turbine and as a heat transfer fluid for desalination. According to other embodiment, exhaust steam from power generation may be used as a heat transfer fluid for desalination.

The apparatus of the fourth aspect of the invention may be used in a method of generating steam for use in an industrial process, the method comprising:
(a) pressurising a working fluid liquid comprising water to a first pressure of at least 50 bar (abs) using the pump;
(b) heating the working fluid liquid in the heater unit to a temperature substantially equal to the saturation temperature of the working fluid liquid at the first pressure; and
(c) flash evaporating the working fluid liquid in the cooperating throttle valve and flash tank to generate the steam,
wherein the working fluid liquid is heated in the heater unit by direct heating in a solar radiation absorption device.

According to a fifth aspect of the present invention, there is provided a solar power plant comprising:
an apparatus for generating steam according to the fourth aspect of the present invention; and
a turbine configured to receive steam from said apparatus for generating steam.

According to a sixth aspect of the present invention, there is provided a method of operating a solar power plant according to the fifth aspect of the present invention, the method comprising:

generating steam in said apparatus for generating steam; and

supplying the steam to the turbine for power generation;

wherein the steam is generated from a working fluid liquid comprising water by:
(a) pressurising the working fluid liquid comprising water to a first pressure of at least 50 bar (abs);
(b) heating the working fluid liquid to a temperature substantially equal to the saturation temperature of the working fluid liquid at the first pressure; and
(c) flash evaporating the working fluid liquid to generate the steam;
and wherein the pressurised working fluid liquid is heated in step (b) by direct heating in a solar radiation absorption device.

According to a seventh aspect of the present invention, there is provided an apparatus for generating steam for use in a desalination process, comprising:
a pump for pressurising a working fluid liquid comprising water to a first pressure of 5-50 bar (abs);
a heating unit downstream of the pump for heating the working fluid liquid to a temperature substantially equal to the saturation temperature of the working fluid liquid at the first pressure; and
a cooperating throttle valve and flash tank downstream of the heating unit for flash evaporating the working fluid liquid to generate steam,

wherein the heating unit comprises a solar radiation absorption device for direct heating of the pressurised working fluid.

The heating unit may be in fluid communication with the flash tank via the throttle valve.

The solar radiation absorption device may comprise one or more parabolic trough solar absorption devices. Alternatively, or in addition, the solar radiation absorption device may comprise one or more linear Fresnel solar radiation absorption devices.

The or each parabolic trough device may comprise a stationary collector pipe and may for example comprise a parabolic trough device according to GB1008032.3

The apparatus may further comprise a recycle loop which may be configured to feed working fluid liquid from the flash tank to the pump.

According to an eighth aspect of the present invention, there is provided a desalination plant comprising:
an apparatus for generating steam according to the seventh aspect of the present invention; and
an evaporator configured to receive steam from said apparatus for generating steam.

According to a ninth aspect of the present invention, there is provided a method of operating a desalination plant according to the eighth aspect of the present invention, the method comprising:
generating steam in said apparatus for generating steam; and
supplying the steam to the evaporator for evaporating water vapour from brine using heat transfer;
wherein the steam is generated from a working fluid liquid comprising water by:
(a) pressurising the working fluid liquid comprising water to a first pressure of 5-50 bar (abs);
(b) heating the working fluid liquid to a temperature substantially equal to the saturation temperature of the working fluid liquid at the first pressure; and
(c) flash evaporating the working fluid liquid to generate the steam; and wherein the pressurised working fluid liquid is heated in step (b) by direct heating in a solar radiation absorption device.

According to a tenth aspect of the present invention, there is provided a combined solar power plant and desalination plant comprising:
an apparatus for generating steam according to the fourth aspect of the present invention;
a first turbine configured to receive steam from said apparatus for generating steam;
optionally one or more further turbines in series with the first turbine and each other and each configured to receive steam from its immediately upstream turbine; and
an evaporator configured to receive steam from the first turbine or the final turbine in the series of turbines.

### BRIEF DESCRIPTION OF THE DRAWINGS

For a better understanding of the present invention, and to show how it may be carried into effect, reference will now be made, by way of example, to the following drawings, in which:

FIG. 1 is a simplified block diagram of a solar power plant according to an embodiment of the present invention;

FIG. 2 is a simplified block diagram of a desalination plant according to an embodiment of the present invention;

FIG. 3 is a representative block diagram of a brine evaporator.

### DETAILED DESCRIPTION OF THE INVENTION

The present invention comprises an apparatus and method for generating steam. The apparatus and method may be enhanced with additional preheating and superheating stages, and may be employed for use in power generation, desalination or other industrial process.

Apparatus according to the present invention comprises a pump for pressurising feed water, a heating unit downstream of the pump for heating the feed water, and a cooperating throttle valve and flash tank downstream of the heating unit for flash evaporating the feed water to generate saturated steam. The feed water may already be pressurised, in which case the pump provides an additional increase in pressure.

The pump, heating unit and cooperating throttle valve and flash tank are all in fluid communication, such that water may be flowed from the pump to the heating unit and on to the flash tank. The pump comprises a pumping unit operable to supply feed water to the heating unit at a controlled mass flow rate and pressure. In a preferred embodiment, for power generation applications, the pump may be a high pressure pump and may be operable to supply feed water at a rate of at least 120 kg/s, or at a rate of at least 200 kg/s or at a rate of at least 300 kg/s or at a rate of at least 400 kg/s or at a rate of at least 500 kg/s, and preferably at a rate of more than 1500 kg/s, or no more than 1250 kg/s, or no more than 1000 kg/s, or no more than 750 kg/s. For example, the pump may be operable to supply feed water at a rate of between 500 kg/s and 1500 kg/s. The pump may further be operable to supply feed water at operating pressures of at least 50 bar (abs) or at least 80 bar (abs), and preferably no more than 200 bar (abs) or no more than 160 bar (abs) or no more than 140 bar (abs). Suitable ranges of operating pressure are between 80 and 200 bar (abs) or between 50 and 160 bar (abs). In other embodiments, for applications including desalination, the pump may supply feed water at between 50 kg/s and 100 kg/s and at operating pressures of at least 5 bar (abs), and preferably no more than 50 bar (abs) or no more than 20 bar (abs). Suitable ranges of operating pressure are between 5 and 50 bar (abs) or between 5 and 20 bar (abs). The pump supplies water to the heating unit at a first pressure P. Other pumps may be provided within a system in which the apparatus of the present invention is employed. Such pumps may set a base line pressure for water flowing through the system and thus into the pump of the present invention, meaning that water arriving at the pump of the present invention may already be pressurised. The pump of the present invention may thus supply only a final small increase in pressure such that water delivered to the heating unit is at the desired pressure P, which will ensure the water remains in liquid form as it is heated in the heating unit.

The heating unit comprises one or more solar radiation absorption devices for direct heating of the pressurised water. By “direct heating” is meant that the respective fluid is heated by direct contact with a heated element in the solar radiation absorption device, as opposed to indirect heating, in which at least one heat transfer fluid is used to carry heat from the solar radiation absorption device and transfer the heat to the respective fluid. Solar radiation absorption devices typically comprise a reflector, configured to reflect solar radiation and focus it upon a collector. Fluid is heated in the collector by contact with a heated element, for example by flowing through a passage defined in the collector, the walls of which are heated by solar energy from the reflector. The one or more solar radiation absorption devices of the heating unit may be linear Fresnel solar collectors, in which a plurality of linear reflecting elements focuses solar energy on a fixed collector tube, positioned at a common focal point of the reflectors. Alternatively, according to a preferred embodiment, the one or more solar radiation absorption devices may be linear parabolic trough collectors, in which a linear parabolic reflector focuses solar energy onto a collector pipe fixed along its focal axis. A plurality of such parabolic trough collectors may be employed in a cooperating array with appropriate interconnections in series and/or in parallel.

Water is heated in the heating unit to a temperature substantially equal to the saturation temperature of the water at the first pressure P. Thus, the temperature to which the water will be heated in the heating unit is dependent upon the pressure at which it is supplied to the heating unit. It will be appreciated that some small pressure loss across the heating unit may be expected, of the order of 1%, although this pressure loss should be minimised. The heating unit is thus configured to heat the pressurised water to the saturation temperature of the water at the pressure at which it exits the heating unit. This pressure will be as close as possible to the first pressure P, allowing for pressure losses over the heating unit. Heating within the heating unit is controlled by controlling the mass flow rate through the solar radiation absorption device(s) and may thus be closely controlled.

The cooperating throttle valve and flash tank receive saturated pressurised water directly from the heating unit and flash evaporate the water to generate saturated steam at a lower temperature and pressure. In flash evaporation, saturated vapour is generated by subjecting saturated liquid to a sudden reduction in pressure. Both the generated saturated vapour and the remaining saturated liquid are cooled to the saturation temperature of the fluid at the new reduced pressure. In a preferred embodiment, the water may be flashed to a pressure between 100 and 140 bar (abs), at a flash ratio of between 5% and 15%. In other embodiments (such as desalination), the water may be flashed to a pressure of 1-1.5 bar (abs), for example, to approximately atmospheric pressure, at a flash ratio of between 5% and 25%. According to embodiments of the invention, the apparatus further comprises a recycle loop operable to recycle remaining liquid water from the flash tank back to the pump.

The pump, heating unit and cooperating throttle valve and flash tank together comprise a steam generating zone. According to embodiments of the invention, the apparatus further comprises a preheating zone upstream of the steam generating zone and a superheating zone downstream of the steam generating zone. The preheating zone, steam generating zone and superheating zone are in fluid communication, such that water may be flowed from the preheating zone to the steam generating zone and saturated and/or superheated steam may be flowed from the steam generating zone to the superheating zone.

The preheating zone comprises a further solar radiation absorption device and preferably comprises an array of linear Fresnel solar collectors. The preheating zone may comprise a plurality of individual zones of one or more dedicated preheating units, each having an inlet to admit feed water and an outlet to discharge preheated feed water. In alternative embodiments, the preheating zone may comprise a heating element that is heated by non solar means, such as for example the combustion of a fossil fuel, a biofuel or a biomass material. The temperature and pressure of the feed water supplied to the preheating zone will depend upon the particular application in which the invention is employed. In the case of power generation, the feed water will typically comprise condensate from the condenser, which may already have undergone a degree of preheating using auxiliary steam from the turbines. The preheating zone may receive feed water at between 80 and 150 bar absolute.

The superheating zone comprises a further solar radiation absorption device and according to one embodiment, comprises a tower solar absorption device. Such devices, also known as “power towers”, typically comprise a tube type collector, supported within a tower structure for flowing a fluid to be heated. An array of planar, independently moveable mirrors or “heliostats” is arranged around the tower structure to focus solar radiation on the collector. According to other embodiments, the superheating zone comprises an array of linear Fresnel solar collectors. Such collectors may not achieve the same degree of super heating as a tower device but they represent a lower cost option. In alternative embodiments, the superheating zone may comprise a heating element that is heated by non solar means, such as for example the combustion of a fossil fuel, a biofuel or a biomass material. The superheating zone may comprise a plurality of individual zones of one or more dedicated superheating units. According to one embodiment of the invention, the superheating zone comprises first and second superheating stages. The first superheating stage comprises a solar device, such as a solar tower absorption device or an array of linear Fresnel collectors, and the second superheating stage comprises a heating element that is heated by non solar means, such as the combustion of a fossil fuel, a biofuel or a biomass material. The first and second superheating stages are in fluid communication, such that superheated steam may be flowed from the first superheating stage to the second superheating stage.

The invention may be employed to generate steam for a variety of industrial processes, including power generation and desalination. The invention may also be employed to generate steam for combined power generation and desalination, preferably wherein the steam is employed both to drive a turbine and as a heat transfer fluid for desalination, and more preferably wherein exhaust steam from power generation is used as a heat transfer fluid for desalination.

Further, the invention may be employed to generate steam in a combined solar power plant and desalination plant comprising: an apparatus of the invention for generating steam; a first turbine configured to receive steam from said apparatus for generating steam; optionally one or more further turbines in series with the first turbine and each other and each configured to receive steam from its immediately upstream turbine; and an evaporator configured to receive steam from the first turbine or the final turbine in the series of turbines.

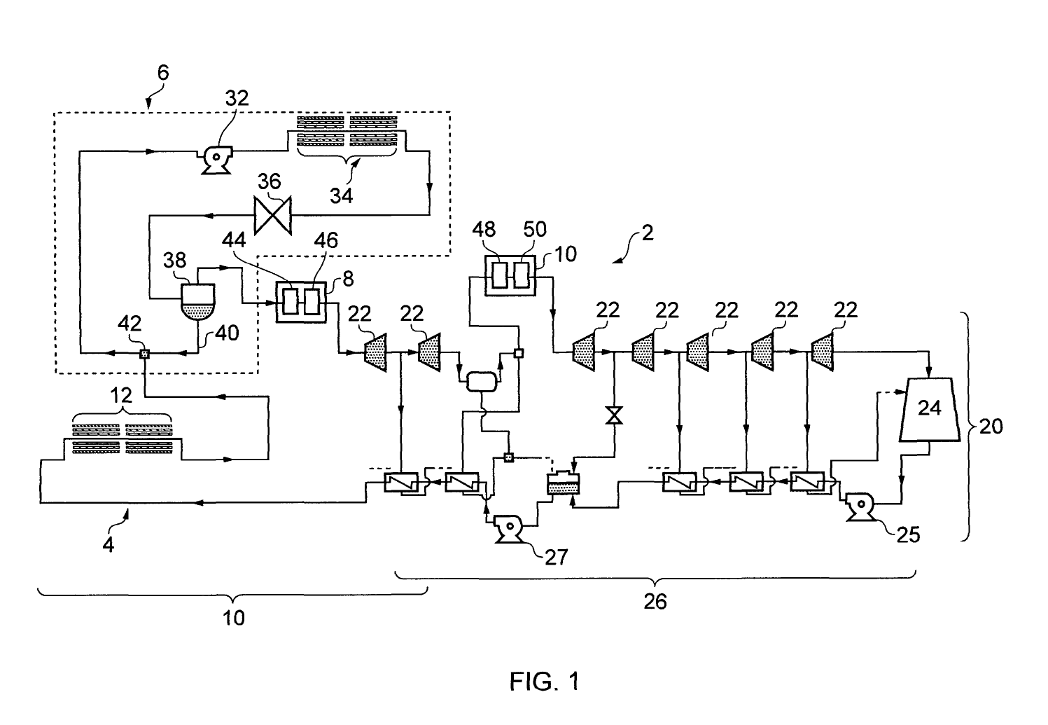

FIG. 1 illustrates a solar power plant in accordance with an embodiment of the present invention. The solar power plant 2 comprises a steam generating region 10 and a power generating region 20. The steam generating region 10 comprises a preheating zone 4, a steam generating zone 6 and first and second superheating zones 8, 10. The power generating region 20 comprises a plurality of turbines 22, a condenser 24, a plurality of preheating heat exchangers 26, a low pressure pump 25 and a high pressure pump 27.

The preheating zone 4 comprises a solar field 12 formed from an array of linear Fresnel solar collectors. The preheating zone 4 is in fluid communication with the steam generating zone 6 to supply preheated feed water to the steam generating zone. The steam generating zone 6 comprises a high pressure pump 32, a solar field 34 and a cooperating throttle valve 36 and flash tank 38. The high pressure pump 32 receives water from the preheating zone 4 and supplies water to the solar field 34 at controlled mass flow rate and pressure. The solar field 34 comprises an array of parabolic trough solar collectors, of the type discussed above. The solar field 34 is in fluid communication with the throttle valve 36 which supplies fluid to the flash tank 38.

Pressurised liquid for flash evaporation is thus supplied directly from the solar field 34 to the flash tank 38 via the throttle valve 36 without requirement for temporary storage. A recycle loop 40 recycles liquid water from the flash tank 38 back to the high pressure pump, mixing with feed water supplied from the preheating zone 4 at a mixer 42.

Each of the first and second superheating zones 8, 10 comprises a first superheating stage 44, 48 and a second superheating stage 46, 50. The first superheating stages 44, 48 comprise solar towers, having an array of planar reflectors focusing light on a collector held within a tower structure. The second superheating stages 46, 50 comprise fossil fuel burners. The steam generating zone 6 is in fluid communication with the first superheating zone 8 via the vapour outlet from the flash tank 38. The first superheating zone is also in fluid communication with a first plurality of turbines 22 and the second superheating zone is in fluid communication with both the first plurality of turbines 22 and a second plurality of turbines 22.

In operation, condensate from the condenser 24 is flowed through the plurality of preheating heat exchangers 26 via the low and high pressure pumps 25, 27. Condensate from the condenser may be substantially under vacuum, at pressures less than 0.2 bar (abs) and at a temperature of between 30 and 70° C. In the preheating heat exchangers 26, auxiliary steam from the turbines 22 is used to preheat the condensate from the condenser 24. The low and high pressure pumps 25, 27 circulate water through the system and increase the pressure of the condensate, setting a base line pressure for the flash tank 38. By the time the condensate is flowed to the preheating zone 4 as feed water it may be at a temperature of 150 to 250° C. and at a pressure of 80 to 140 bar. In the preheating zone 4, comprising the solar field 12, the feed water is heated to a temperature of 300 to 350° C. and exits the solar field 12 at this temperature. The degree of pre heating provided by the solar field is determined by the area of the solar field which is in use and by the angle of mirror focus, and these factors are closely controlled to provide the desired exit temperature. The preheated feed water is then flowed to the high pressure pump 32, where the pressure is increased to the pressure P, which may be between 100 and 170 bar. This increase in pressure over the base line pressure set by the low and high pressure pumps 25, 27 ensures that as the feed water is heated in the solar field 34, the water remains in the liquid state. The pressurised water is then flowed to the steam generating solar field 34, where it is heated to a temperature substantially equal to the saturation temperature of the water at the pressure P. In a preferred embodiment the water is heated to the saturation temperature of the water at the pressure at which it exits the solar field 34. This pressure is approximately equal to the pressure P at which the pump 32 supplies the pressurised water, but may be up to 1% lower owing to pressure losses over the solar field 34. For example the pressurised water may be heated to between 310 and 360° C.

From the solar field 34, the pressurised, saturated water is flowed directly to the cooperating throttle valve 36 and flash tank 38, where the pressure of the water is reduced by between 10 and 50 bar and between 5 and 15% of the water is flash evaporated to steam. Both the generated steam and the remaining liquid are cooled to the water saturation temperature at the new reduced pressure. The 85 to 95% of water that remains liquid in the flash tank is flowed, via the recycle loop 40 to the mixer 42, where it is added to the preheated feed water flowing from the preheating solar field 12 to the high pressure pump 32.

The saturated steam generated in the flash drum 38 is flowed to the first superheating zone 8. Within the first superheating zone 8 the saturated steam is first flowed though the first superheating stage 44 comprising a solar power tower. In the solar power tower, the steam is superheated to between 400 and 490° C. The superheated steam is then flowed to the second superheating stage 48 comprising a biomass or fossil fuel burner. In the second stage, the steam is further superheated to between 500 and 560° C., and is preferably superheated to the optimum temperature for turbine efficiency.

From the first superheating zone 8, the superheated steam is flowed to the first plurality of turbines 22, in which both pressure and temperature of the steam fall as the steam drives the turbines 22. From the first plurality of turbines 22 the steam, now at 5 to 25 bar and 160 to 260° C. is flowed to the second superheating zone 10, where it is reheated to between 500 and 560° C. through the first and second superheating stages 48, 50. From the second superheating zone 10, the superheated steam is flowed to the second plurality of turbines 22 and on to the condenser 24. Auxiliary steam from the turbines 22 is flowed to the preheating heat exchangers 26 in order to provide a first level of preheating to the feed water condensate as discussed above.

It will be appreciated that while the solar fields 12, 34, 44 and 48 have been described as comprising specific types of solar absorption device, each of the preheating, pressurised heating and superheating solar fields may comprise any appropriate type of solar absorption device, including linear Fresnel, parabolic trough, and power towers. In addition, the preheating and superheating zones may comprise non solar heating elements, such as for example burners for conventional fossil fuels, a biofuel or a biomass material. These may be as an alternative, or in addition to the solar radiation absorption devices.

It will also be understood that the technology of the available solar radiation absorption devices may place a finite limit on the temperature to which steam can be superheated in these devices. In certain instances, it may be that the maximum achievable temperature using solar thermal energy is below the optimum temperature for turbine efficiency. Even if the optimum temperature can be achieved using solar technology, this may not represent the most efficient choice. For example, it may be possible to use only a single superheating stage in each superheating zone, employing a tower solar heating device to superheat the steam to approximately 550° C. However, the final 60° C. of superheating using a solar tower can impose a very high cost, as with increasing temperatures a greater amount of heat is radiated back to the environment. Thus, it may be desirable to combine both solar and non solar heating means to achieve a desired superheating temperature. For example, the majority of the superheating may be achieved using a solar power tower, employing renewable energy resources, with fossil fuels or biomass only employed to achieve the final 60 to 80° C. of superheating. The superheating zones may comprise any appropriate combination of solar and non solar devices to achieve the desired exit superheat temperature in the most efficient manner.

The pressurised nature of the water flowing through the pressurised solar field 12 places particular constraints on the type of solar absorption device that can be employed for this field. In particular, standard linear parabolic trough collectors, in which the collector pipe rotates with the reflecting surface, are not suitable. The swivel joints required in the connecting pipe work for such collectors are unable to contain the high pressure at which the water is supplied by the high pressure pump 32. Conventional solar fields, used to heat a heat transfer fluid for later boiling of water, are not required to accommodate such high pressure liquids flowing through them. One design of linear parabolic trough collector that is particularly suited to use in the pressurised solar field 12 is the linear parabolic trough having a stationary collector pipe. An example of such a device is disclosed in GB1008032.3 and comprises a stationary collector pipe mounted on the focal line of a linear parabolic reflector. The reflector is mounted to rotate about the stationary collector, avoiding the need for swivel joints or flexible pipe work that would be unable to withstand the pressures required in the pressurised solar field 12.

An important advantage of the concentrated solar power plant described above is the elimination of the need either for a heat transfer fluid loop or for two phase flow within collector tubes. By removing the need for a heat transfer fluid loop, the present invention affords considerable reductions in capital expenditure, as well as simplifying operating of the plant by allowing the plant to run only on water. In employing flash evaporation to generate steam, the present invention also removes the need for boiling within a solar collector, and thus the occurrence of two phase flow within collector pipes which is known to cause issues with controllability and collector pipe buckling. The concentrated solar power plant described above also provides improvements in thermal efficiency by matching the water enthalpy curve but without pinch. Additional capital cost savings, reduced solar field heat losses and increased turbine efficiency may also be achieved for example by matching the selection of heat collector with the three heating zones of the plant: preheating, pressurised heating and superheating.

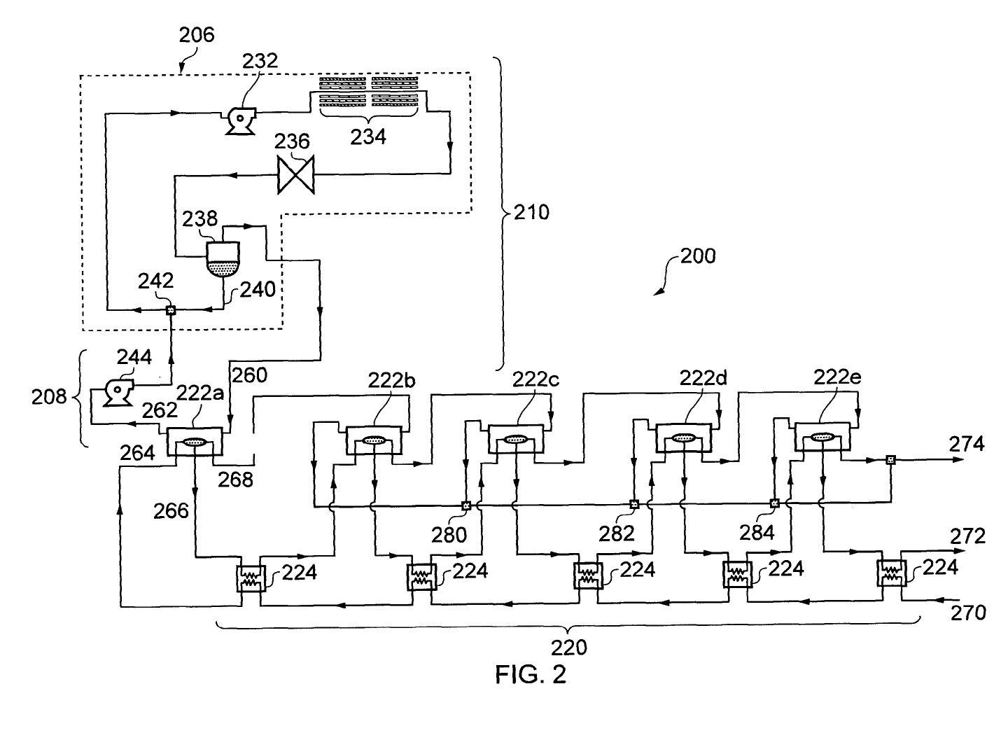

As noted above, the invention may be employed to generate steam for other industrial process, including desalination. FIG. 2 illustrates a desalination plant in accordance with another embodiment of the invention. The desalination plant 200 comprises a working fluid loop 210 and a brine evaporating region 220. The working fluid loop 210 comprises a steam generating zone 206 and a condensing zone 208. The brine evaporating region 210 comprises a plurality of cooperating brine evaporators 222a to 222e and preheating heat exchangers 224.

The steam generating zone is configured substantially as described above with respect to the concentrated solar power plant of FIG. 1. The steam generating zone 206 comprises a pump 232, a solar field 234 and a cooperating throttle valve 236 and flash tank 238. The pump 232 receives fluid from the condensing zone 208 and supplies fluid to the solar field 234 at controlled mass flow rate and pressure. The solar field 234 comprises an array of parabolic trough solar collectors, of the type discussed above. The solar field 234 is in fluid communication with the throttle valve 236 which supplies fluid to the flash tank 238. A recycle loop 240 recycles liquid water from the flash tank 238 back to the pump 232, mixing with feed water supplied from the condensing zone 208 at a mixer 242.

The condensing zone comprises an operating pump 244 and a working fluid region of a first brine evaporator 222a. The first brine evaporator 222a receives saturated steam from the flash tank 238. The saturated steam is condensed in the brine evaporator and flowed via pump 244 back to the steam generating zone 206. The pump 244 does not pressurise the saturated steam but merely overcomes pumping and elevation losses.

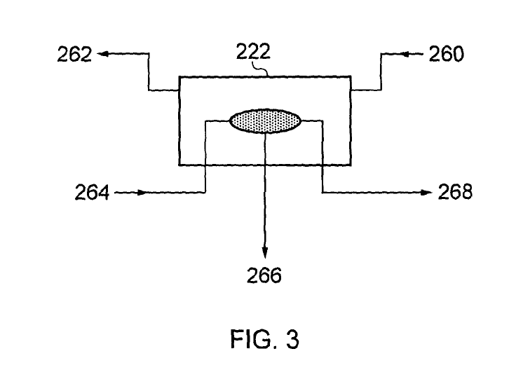

The brine evaporating region 220 of the plant 200 comprises a plant brine inlet 270, a plant concentrated brine outlet 272, a plant fresh water outlet 274 and a plurality of cooperating brine evaporators 222a to 222e and preheating heat exchangers 224. A representative brine evaporator 222 is illustrated in FIG. 3 and comprises a steam inlet 260, a condensate outlet 262, a brine inlet 264, a concentrated brine outlet 266 and a steam outlet 268. Heat exchange elements (not shown) within the brine evaporator contact the steam entering at the steam inlet 260 with the feed brine water entering at the brine inlet 264, evaporating water vapour off the feed brine water by heat transfer. The remaining concentrated brine water exits the evaporator 222 via the concentrated brine outlet 266 and the evaporated pure water vapour exits the evaporator via the steam outlet 268. The condensed steam used to evaporate the water vapour from the brine exits the evaporator 222 at the condensate outlet 262.

In operation, the working fluid loop 210 generates steam for the first stage of brine evaporation in the first brine evaporator 222a. Condensate is flowed by the pump 244 of the condensing zone 208 to the pump 232 of the steam generating zone 206. The pressure of the condensate is increased by the pump 232 to between 5 and 15 bar. The pressurised water is then flowed to the steam generating solar field 234, where it is heated to a temperature substantially equal to the saturation temperature of the water at the pressure at which it exits the solar field 234. This pressure is substantially equal to the pressure at which the pump 232 supplies the pressurised water, but may be slightly lower owing to pressure losses over the solar field 234. For example the pressurised water may be heated to between 150 and 200° C.

From the solar field 234, the pressurised, saturated water is flowed to the cooperating throttle valve 236 and flash tank 238, where the pressure of the water is reduced to substantially atmospheric pressure and between 15 and 20% of the water is flash evaporated to steam. Both the generated steam and the remaining liquid are cooled to the water saturation temperature at the new reduced pressure. The 80 to 85% of water that remains liquid in the flash tank is flowed, via the recycle loop 240 to the mixer 242, where it is added to the condensate flowing from the first brine evaporator 222a to the pump 232.

The saturated steam generated in the flash drum 238 is flowed to the steam inlet 260 of the first brine evaporator 222a. The steam is condensed in the first brine evaporator 222a and exits the first brine evaporator 222a via the condensate exit 262. The condensed water is then flowed via the condensing zone pump 244 back to the steam generating zone 206 for further pressurising, heating and flash evaporation. The working fluid loop is thus a closed loop, generating steam to drive evaporation in the first brine evaporator.

Brine in the form of seawater enters the plant 200 at the plant brine inlet 270. The brine is then fed through the plurality of preheating heat exchangers 224, where the temperature of the brine is raised through heat transfer with concentrated brine from the plurality of brine evaporators 222. The preheated brine is then flowed to the brine inlet 264 of the first brine evaporator 222a where steam from the working fluid loop causes evaporation of pure water from the brine. Between 10% and 20% of the brine entering the brine evaporator 222a may be evaporated to steam. The concentrated liquid brine remaining after evaporation exits the brine evaporator 222a via the concentrated brine outlet 266. The concentrated brine is then flowed to the first preheating heat exchanger and on to the brine inlet of the second brine evaporator 222b. The increasingly concentrated brine is cycled through all of the brine evaporators 222 and preheating heat exchangers 224 before being discharged from the plant 200 at the plant concentrated brine outlet 272. The pure water evaporated from the brine in the first brine evaporator 222a exits the first brine evaporator 222a as steam via the steam outlet 268. The steam is then flowed to the steam inlet 260 of the second brine evaporator 222b, where it is used to evaporate additional water vapour off the brine entering the second brine evaporator 222b. During this process, the steam is condensed to water and exits the second brine evaporator at the condensate outlet 262. From the condensate outlet 262, the water is flowed to the plant fresh water outlet 274. Water exiting from the third, fourth and fifth brine evaporators 222c, 222d, 222e is joined to the flow of water from the second brine evaporator 222b via mixers 280, 282, 284.

It will be appreciated that the precise configuration of the brine evaporators 222 may be varied according to plant requirements, for example in order to minimise the number of mixers required or to make other efficiency savings. In addition, the brine evaporators may be operated under reduced pressure (vacuum) conditions.

Power generation and desalination may be combined in a single system in accordance with the present invention. Thus, instead of condensing low pressure steam from the output of the final turbine in the solar plant as shown in FIG. 1, the solar plant is coupled to a brine evaporating region having the configuration of the brine evaporating region 220 of the desalination system of FIG. 2. In this embodiment, the superheated steam is flowed to the second plurality of turbines 22 in series. From the final turbine 22 in the series, the steam is flowed to the steam inlet 260 of the first brine evaporator 222a of the brine evaporating region 220 of the system illustrated in FIG. 2.

In this embodiment, steam is extracted from the final turbine 22 of the series at a temperature and pressure suitable to drive evaporation in the desalination step. For example, the steam may be extracted from the final turbine 22 in the series at a temperature above 100° C. and a pressure above atmospheric pressure, for example a temperature of 224° C. and a pressure of 1.4 bar (abs.). To this end, fewer turbine units 22 may be provided than in the power generation only embodiment illustrated in FIG. 1.

Steam is flowed to the first brine evaporator 222a, and is condensed there as described above in relation to FIG. 2 and exits the first brine evaporator 222a via the condensate exit 262 from where it is flowed back to the steam generating zone via the plurality of preheating exchangers 26. Desalination of brine is then accomplished in a series of brine evaporators 222 in the manner shown in FIG. 2.

In this embodiment, steam is removed from the second plurality of turbines 22 at a temperature and pressure which is higher than that in power generation embodiment of FIG. 1, and so there is a sacrifice in the electricity generated by the solar power plant, compared to the embodiment of FIG. 1. For example, the system may be operated such that there is a sacrifice of 20% in the electricity generated by the solar power plant, compared to the embodiment of FIG. 1. However, the overall thermal efficiency of the combined power generation and desalination embodiment is approximately 65 to 70%, in contrast to the thermal efficiency in embodiments involving power generation alone, which is approximately 40 to 45%.

1. A method of generating steam for use in an industrial process, the method comprising:
(a) pressurising a working fluid liquid comprising water to a first pressure of at least 50 bar (abs);
(b) heating the working fluid liquid to a temperature substantially equal to the saturation temperature of the working fluid liquid at the first pressure; and
(c) flash evaporating the working fluid liquid to generate the steam;
wherein the pressurised working fluid liquid is heated in step (b) by direct heating in a solar radiation absorption device.

2. A method as claimed in claim 1, wherein the industrial process is power generation or desalination.

3. A method as claimed in claim 1, wherein the flash evaporation is carried out in a flash tank which receives saturated, pressurised water from the solar radiation absorption device via a throttle valve.

4. A method as claimed in claim 1, further comprising preheating the working fluid liquid before pressurising at step (a).

5. A method as claimed in claim 4, wherein the preheating is carried out by direct heating in a solar radiation absorption device.

6. (canceled)

7. A method as claimed in claim 1, further comprising superheating the steam after step (c).

8. (canceled)

9. A method as claimed in claim 7, wherein the superheating is carried out by direct heating in a solar radiation absorption device.

10. A method as claimed in claim 9, wherein the solar radiation absorption device comprises one or more tower solar absorption devices or linear Fresnel solar absorption devices.

11. A method as claimed in claim 7, wherein the superheating comprises first and second superheating stages, the first superheating stage using direct solar heating and the second superheating stage using a non renewable energy source.

12. (canceled)

13. A method as claimed in claim 1, wherein the working fluid liquid remaining after the flash evaporation in step (c) is recycled back to step (a).

14-20. (canceled)

21. An apparatus for generating steam for use in an industrial process, the apparatus comprising:
a pump for pressurising a working fluid liquid comprising water to a first pressure of at least 50 bar (abs);
a heating unit downstream of the pump for heating the working fluid liquid to a temperature substantially equal to the saturation temperature of the working fluid liquid at the first pressure; and
a cooperating throttle valve and flash tank downstream of the heating unit for flash evaporating the working fluid liquid to generate steam,
wherein the heating unit comprises a solar radiation absorption device for direct heating of the pressurised working fluid.

22. An apparatus as claimed in claim 21, wherein the industrial process is power generation.

23. An apparatus as claimed in claim 21, wherein;
the heating unit is in fluid communication with the flash tank via the throttle valve, and/or
the solar radiation absorption device comprises one or more parabolic trough solar absorption devices.

24-25. (canceled)

26. An apparatus as claimed in claim 21, further comprising a recycle loop configured to feed the working fluid liquid from the flash tank to the pump.

27. An apparatus as claimed in claim 21, wherein the pump, heating unit and cooperating throttle valve and flash tank together comprise a steam generating zone, and the apparatus further comprises a preheating zone upstream of the steam generating zone for preheating the working fluid liquid, and a superheating zone downstream of the steam generating zone for superheating the steam.

28. An apparatus as claimed in claim 27, wherein the preheating zone comprises a solar radiation absorption device for direct heating of the working fluid liquid.

29-30. (canceled)

31. An apparatus as claimed in claim 27, wherein the superheating zone comprises a solar radiation absorption device for direct heating of the steam.

32. (canceled)

33. An apparatus as claimed in claim 27, wherein the superheating zone comprises first and second superheating stages, the first superheating stage comprising a tower solar radiation absorption device or a linear Fresnel solar absorption device and the second superheating stage comprising a fossil fuel burner.

34. An apparatus as claimed in claim 21, wherein the industrial process is combined power generation and desalination, and wherein the steam is employed both to drive a turbine and as a heat transfer fluid for desalination.

35. An apparatus according to claim 34, wherein exhaust steam from power generation is used as a heat transfer fluid for desalination.

36. (canceled)

37. A solar power plant comprising:
an apparatus for generating steam as claimed in claim 21; and
a turbine configured to receive steam from the apparatus for generating steam.

38-45. (canceled)

46. A combined solar power plant and desalination plant comprising:
an apparatus for generating steam as claimed in claim 21;
a first turbine configured to receive steam from the apparatus for generating steam;
optionally one or more further turbines in series with the first turbine and each other and each configured to receive steam from its immediately upstream turbine; and
an evaporator configured to receive steam from the first turbine or the final turbine in the series of turbines.

47-48. (canceled)
